(19) United States
(12) Patent Application Publication
(10) Pub. No.: US 2002/0024478 A1
(43) Pub. Date: Feb. 28, 2002

(54) Cathode ray tube and image control device

(76) Inventors: Ryo Saito, Kanagawa (JP); Yasunobu Kato, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/908,851

(22) Filed: Jul. 20, 2001

(30) Foreign Application Priority Data
Jul. 21, 2000 (JP) P2000-220180

(51) Int. Cl. G09G 1/06

(52) U.S. Cl. 345/10

(57) ABSTRACT

A multi-beam electron gun of the invention emits two electron beams for each of the three colors from the top and the bottom. A single composite screen is formed as a whole by the electron beam group on the top and the electron beam group on the bottom. Image distortion in all of the scanning screens formed by the electron beam group on the top and the electron beam group on the bottom are corrected by directly correcting the image data. At this time, correction of the image data is separately performed on the data for each electron beam, and is performed by changing the arrangement of pixels in terms of space and time. Thereby, image display using the multi-beam electron gun can be excellently performed.

### BACKGROUND OF THE INVENTION

1. Field of the Invention

The invention relates to a cathode ray tube with a multi-beam electron gun and an image control device in the cathode ray tube.

2. Description of the Related Art

In the related art, cathode ray tubes (CRT) have been in wide use for television sets, monitors for computers and the like. A cathode ray tube is for forming a scanning screen on a tube screen by emitting an electron beam to a phosphor screen from an electron gun provided inside the tube and deflecting the electron beam electromagnetically by a deflection yoke or the like. A cathode ray tube for color display has three cathodes inside an electron gun, which emit three electron beams for red (R), green (G) and blue (B). This kind of cathode ray tube forms one color screen by an electron beam emitting. Recently, however, a cathode ray tube has been proposed in which a plurality of electron beams are emitted for one color forming one screen as a whole. For example, two electron beams each for red, green, and blue totaling 6 electron beams (3×2=6) are emitted from one electron gun forming one screen as a whole. As described, the electron gun is formed to emit a plurality of electron beams for each color is also referred to as a “multi-beam electron gun.” Techniques regarding multi-beam electron guns are disclosed in, for example, Japanese Patent Application Laid-open Hei 8-506923 and Japanese Patent Application Laid-open Hei 11-16504.

In an electron gun for color display, it is physically impossible to provide all the cathodes for each color on the same axis. For example, if the cathodes are arranged with a cathode for green being in the center, the cathodes for red and green are to be placed away (eccentric) from the central axis of the cathode for green. Therefore, the electron beams for red and blue are emitted from the electron gun being away from the electron beams for green. When the electron beams are emitted in such a state, the electron beams for each color are differently influenced by magnetic fields, respectively, by deflection yokes and the like. Therefore, it becomes difficult to align the convergence position of the electron beams. The phenomenon of shift in the positions of electron beams for each color on a tube screen is referred to as “misconvergence.” Also, in a cathode ray tube, in general, the image distorts as going towards the peripheral portion of the screen due to its structure and it is known as an “image distortion”. In the electron gun for color display, as described, the electron beams for each color are emitted from different positions. Therefore, different image distortions are caused in each and every color. In a cathode ray tube with a multi-beam electron gun, it is necessary that more scanning screens are to be formed compared to a general cathode ray tube and each of the scanning screens is to be appropriately superimposed. However, if there is misconvergence or image distortion generated in each of the scanning screens, there may be a case where the scanning screens are inappropriately superimposed and the quality of image is largely deteriorated.

In the related art, misconvergence and image distortion have been corrected by optimizing the magnetic field inside the tube through adding a deflection yoke for correction or providing a purity magnet (or a ring magnet) with four poles or six poles. However, with such correction method of the related art, it is difficult to completely correct misconvergence and image distortion. Especially, in a cathode ray tube using a multi-beam electron gun, there are more electron beams to be corrected compared to an ordinary cathode ray tube. Therefore, it is practically impossible to completely correct image distortion and misconvergence by controlling the magnetic field as in the correction method of the related art.

For example, as shown in FIG. 20, a case where electron beam groups 111 and 112 for three colors, red, green, and blue, are emitted in two lines on the top and bottom from a multi-beam electron guns is described. At this time, if there is a magnetic distribution 110 from top to bottom inside the tube, both of the electron beam group 111 (R1, G1, B1) on the top and the electron beam group 112 (R2, G2, B2) on the bottom are shifted to left (X direction in FIG. 20). Also, if there is a magnetic distribution in the opposite direction, both of each electron beam group 111 and 112 are shifted to right (−X direction in FIG. 20). As described, it is possible to shift the electron beams to various directions by variously changing the direction of the magnetic distribution 110. However, there is a case where the electron beam cannot be shifted to a desired direction by simply controlling the magnetic distribution 110. For example, it is difficult to simultaneously shift the electron beam group 111 on the top and the electron beam group 112 on the bottom to the opposite direction from each other. Especially, it is practically impossible to simultaneously shift all of six electron beams to different directions.

As described, each electron beam cannot be individually shifted to a given direction by simply controlling the magnetic field. Therefore, misconvergence and image distortion cannot be completely corrected. In addition to performing correction by deflection and the like, it is possible to correct picture signals and improve image distortion by converting picture signals to analog signals to be inputted to cathodes of the electron gun. However, with such correction method by converting the picture signals to analog signals, it is possible to correct image distortion on the same scanning line, that is, in the lateral (horizontal) direction, but is difficult to correct image distortion in the longitudinal (vertical) direction. Therefore, the image distortion cannot be corrected sufficiently.

### SUMMARY OF THE INVENTION

The invention has been designed to overcome the foregoing problems. The object of the invention is to provide a cathode ray tube and an image control device which can display an excellent image using a multi-beam electron gun.

A cathode ray tube and an image control device of the invention comprise an electron gun having a plurality of cathode groups including a cathode for at least one color, and emitting electron beams from each of the cathodes according to a picture signal; an image display where a plurality of scanning screens are formed by a plurality of the electron beams emitted from each cathode of the electron gun and a single screen is formed by a plurality of the scanning screens being superimposed as a whole. Also, a cathode ray tube and an image control device of the invention comprise a storing means for storing correction data for correcting display state of image which is obtained based on an image displayed on the image display; a converting means for converting a picture signal inputted one-dimensionally into a dispersed two-dimensional image data; and a position control means for controlling by correcting through changing the arrangement of pixels in the two-dimensional image data converted by the converting means in terms of time and space by each and every cathode based on the correction data stored in the storing means and then by outputting the corrected image data after re-converting it to a picture signal for display so that a plurality of the scanning screens are appropriately positioned and superimposed to be displayed when image display is performed on the image display.

In a cathode ray tube and an image control device of the invention, a picture signal inputted one-dimensionally is converted into a dispersed two-dimensional image data in a converting means, and correction data for correcting display state of image which is obtained based on an image displayed on the image display is stored in a storing means. Also, by a position control means, correction is performed through changing the arrangement of pixels in the two-dimensional image data in terms of time and space by each and every cathode based on the correction data. Then, the corrected image data is re-converted to a picture signal for display by a position control means and outputted. A plurality of scanning screens are formed by scanning a plurality of electron beams emitted based on the corrected picture signal for display and a plurality of scanning screens are superimposed as a whole. Thereby, a single screen is formed and an image is displayed.

Other and further objects, features and advantages of the invention will appear more fully from the following description.

### BRIEF DESCRIPTION OF THE DRAWINGS

FIG. 1A is an elevation showing the scanning direction of an electron beam in a cathode ray tube of the invention, and FIG. 1B is a cross section taken along the line IB-IB in FIG. 1A.

FIG. 2 is a cross section in the horizontal direction showing the whole structure of the electron gun in the cathode ray tube of the invention along with the tracks of the electron beams.

FIG. 3 is a cross section in the vertical direction showing the whole structure of the electron gun in the cathode ray tube of the invention along with the tracks of the electron beams.

FIG. 4 is an elevation showing the draft of the cathode of the electron gun in the cathode ray tube of the invention.

FIG. 5 is a perspective view showing the arrangement of each cathode of the electron gun in the cathode ray tube of the invention.

FIG. 6 is a block diagram showing the structure of the signal processing circuit in the cathode ray tube of the invention.

FIG. 7A to FIG. 7E are figures for describing the total flow of correction/calculation processing of image data performed in the processing circuit in the cathode ray tube of the invention.

FIG. 8 is an explanatory figure showing a display example of rectangular image when correction processing is not performed on the image by the DSP circuit.

FIG. 9A to FIG. 9F are explanatory figures showing a display example of rectangular image when correction processing is performed on the image by the DSP circuit.

FIG. 10A to FIG. 10C are explanatory figures showing the draft of correction data used in the processing circuit in the cathode ray tube of the invention.

FIG. 11A to FIG. 11C are explanatory figures for showing the conversion state of inputted image when correction/calculation using the correction data is not performed in the processing circuit in the cathode ray tube of the invention.

FIG. 12A to FIG. 12C are explanatory figures for showing the conversion state of inputted image when correction/calculation using the correction data is performed in the processing circuit in the cathode ray tube of the invention.

FIG. 13 is an explanatory figure showing the first method of correction/calculation processing in the cathode ray tube of the invention.

FIG. 14 is an explanatory figure showing the second method of correction/calculation processing in the cathode ray tube of the invention.

FIG. 15 is an explanatory figure showing control points used in the third method of correction/calculation in the cathode ray tube of the invention.

FIG. 16 is an explanatory figure showing interpolation used in the third method of correction/calculation in the cathode ray tube of the invention.

FIG. 17 is an explanatory figure showing extrapolation used in the third method of correction/calculation in the cathode ray tube of the invention.

FIG. 18A to FIG. 18J are explanatory figures showing a model draft of screen scanning in the cathode ray tube according to the second embodiment of the invention in relate to correction processing of the image.

FIG. 19 is an explanatory figure showing another example of scanning direction by the electron beams.

FIG. 20 is an explanatory figure showing the relation between the magnetic field distribution inside the cathode ray tube and the shift direction of the electron beams.

### DETAILED DESCRIPTION OF THE PREFERRED EMBODIMENTS

In the followings, embodiments of the invention will be described in detail by referring to the drawings.

[First Embodiment]

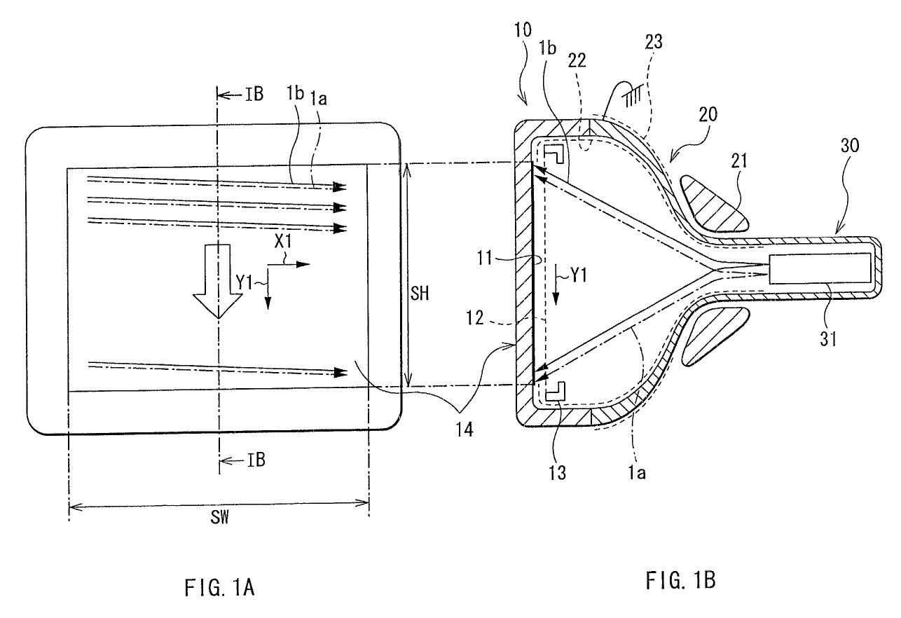

As shown in FIG. 1B, a cathode ray tube according to the embodiment comprises a panel 10 inside which a phosphor screen 11 is formed, and a funnel 20 being formed as one body with the panel 10. A long-narrow neck 30 with an electron gun 31 being built in is formed in the rear end of the funnel 20. The cathode ray tube is formed in a funnel-shape with the panel 10, the funnel 20 and the neck 30. The portion composing the figure of the cathode ray tube is also called a “envelope.” Each opening of the panel 10 and the funnel 20 are fused and attached to each other and the inside is to maintain a high vacuum. In the phosphor screen 11, phosphor patterns which emit light according to incidence of electron beams are formed. The surface of funnel 10 is an image display screen (tube screen) 14 on which image is displayed by emission of the phosphor screen 11. Mainly the phosphor screen 11 and the tube screen 14 correspond to specific examples of “image display” of the invention.

Inside the cathode ray tube, a color selection mechanism 12 is provided so as to face the phosphor screen 11. The color selection mechanism 12 is also called an aperture grill or a shadow mask. The peripheral of the color selection mechanism 12 is supported by a frame 13 and attached inside face of the panel 10. An anode terminal (not shown in figure) for applying anode voltage HV is provided in the funnel 20. In the peripheral region from the funnel 20 to the neck 30, a deflection yoke 21 is attached for deflecting electron beams 1 and 2 emitted from the electron gun 31. The inner face from the neck 30 to the phosphor screen 11 of the panel 10 is covered with an inside-conductive film 22. The inside-conductive film 22 is electrically connected to the anode terminal (not shown in figure) and kept to the anode voltage HV. The peripheral face of the funnel 20 is covered with an outside-conductive film 23.

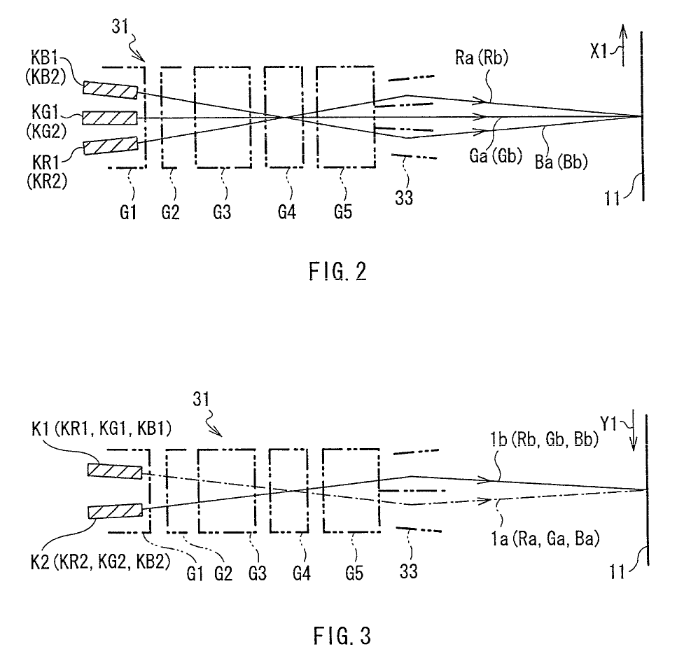

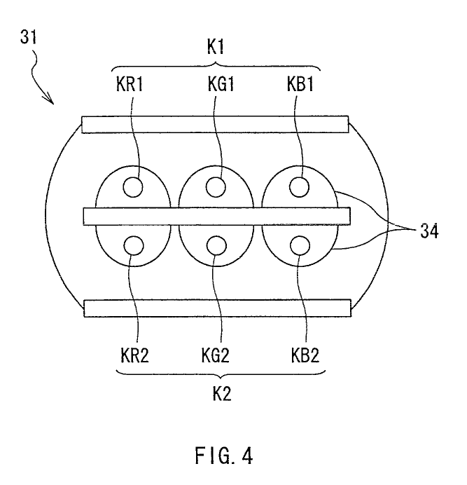

The electron gun 31 is a multi-beam electron gun which emits a plurality of electron beams for one color. The electron gun 31 comprises, as shown in FIG. 2 and FIG. 3, cathode groups K1 and K2 having a plurality of cathodes, a plurality of grid electrodes G1 to G5 and a convergence electrode 33. The electron gun 31 also comprises a heater (not shown in figure) for heating the cathode groups K1 and K2. Inside the electron gun 31, as shown in the elevation in FIG. 4, openings 34 through which the electron beams emitted from each cathode can be passed are formed corresponding to the number of cathode each composing the cathode groups K1 and K2. The grid electrodes G1 to G5 and the convergence electrode 33 form an electron lens system by receiving application of anode voltage HV, a focus voltage or the like, and work as a lens against the electron beams emitted from the cathode groups K1 and K2. The grid electrodes G1 to G5 perform convergence and the like of each electron beam emitted from the cathode groups K1 and K2 by the effect of the lens, and also perform control of emitting amount of electron beams, control of acceleration and the like. The convergence electrode 33 has a role of converging a plurality of electron beams emitted from the cathode groups K1 and K2 on the phosphor screen 11 by prism effect.

The cathode groups K1 and K2 are, as shown in FIG. 4 and FIG. 5, provided in parallel lines in the up-and-down direction (vertical direction). The cathode group K1 on the top is superimposed with a cathode KR1 for red emitting electron beams Ra for red, a cathode KG1 for green emitting electron beams Ga for green, and a cathode KB1 for blue emitting electron beams Ba for blue, being arranged in order. The cathode group K2 on the bottom is superimposed in the same manner with a cathode KR2, a cathode KG2 and a cathode KB2 being arranged in order. Each cathode in the cathode groups K1 and K2 is placed inclining towards the center at an appropriate angle so that the electron beams are easily converged. The positioning of each cathode is not limited to the one shown in figure but the cathodes may be arranged in other orders. For example, the cathode for red and the cathode for blue may be placed in the reversed order.

Each cathode in the cathode groups K1 and K2 is to emit thermion according to the amount of picture signals by being heated by a heater (not shown in figure) and receiving an application of cathode-drive voltage according to the amount of picture signals. As shown in FIG. 3, an electron beam group 1a (Ra, Ga, Ba) emitted from the cathode group K1 on the top receives the electron lens effect by the grid electrodes G1 to G5 and the convergence electrode 33, and then is emitted to the phosphor screen 11 from the bottom in the electron gun 31 at last. On the other hand, an electron beam group 1b (Ra, Ga, Ba) emitted from the cathode group K2 on the bottom receives the electron lens effect by the grid electrodes G1 to G5 and the convergence electrode 33, and then is emitted to the phosphor screen 11 from the top in the electron gun 31 at last. As described, the electron gun 31 emit two electron beams each for three colors, red, green, blue, in the top and bottom, totaling six electron beams (3×2=6). The electron beams for each color emitted from the electron gun 31 pass through the color selection mechanism 12, respectively, and are irradiated to the corresponding color of phosphor on the phosphor screen.

In the cathode ray tube, as shown in FIG. 1A, by the electron beam group 1b on the top and the electron beam group 1a on the bottom, so-called a line scanning is performed in the horizontal deflection direction from left to right (X1 direction in the figure) when looked from the display side, and so-called a field scanning is performed in the vertical deflection direction from top to bottom (Y1 direction in the figure). At this time, it is possible to form two scanning screens with two colors by the electron beam group 1b on the top and the electron beam group 1a on the bottom. However, in the cathode ray tube, scanning is simultaneously performed in the same position on the phosphor screen by the electron beam group 1b on the top and the electron beam group 1a on the bottom, thereby forming a single screen as a whole. In FIG. 1A, the scanning position of the electron beam group 1b on the top and the electron beam group 1a on the bottom are drawn shifted from each other on the screen in order to show each track of the electron beams. However, the scanning positions of the electron beams coincide with each other in practice. In FIG. 1A, SH represents an effective screen region in the vertical direction and SW represents an effective screen region in the horizontal direction.

In general, there are methods of screen scanning of the cathode ray tube called interlace scanning and progressive scanning. The interlace scanning method is a method in which 1 frame of image is displayed by performing field scanning twice. The progressive scanning is a method in which 1 frame of image is displayed within one vertical scanning period. The cathode ray tube is applicable to both of the scanning methods. In the cathode ray tube, scanning is simultaneously performed in the same position on the phosphor screen by the electron beam group 1b on the top and the electron beam group 1a on the bottom by using any of the two methods.

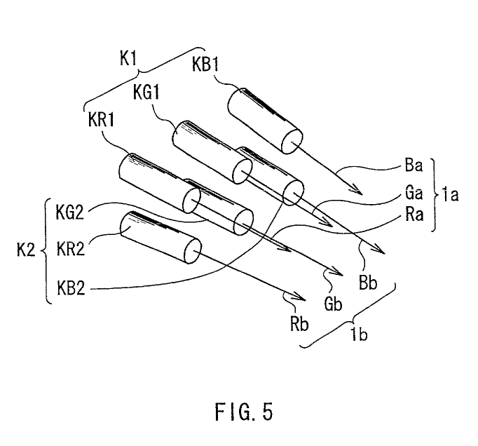

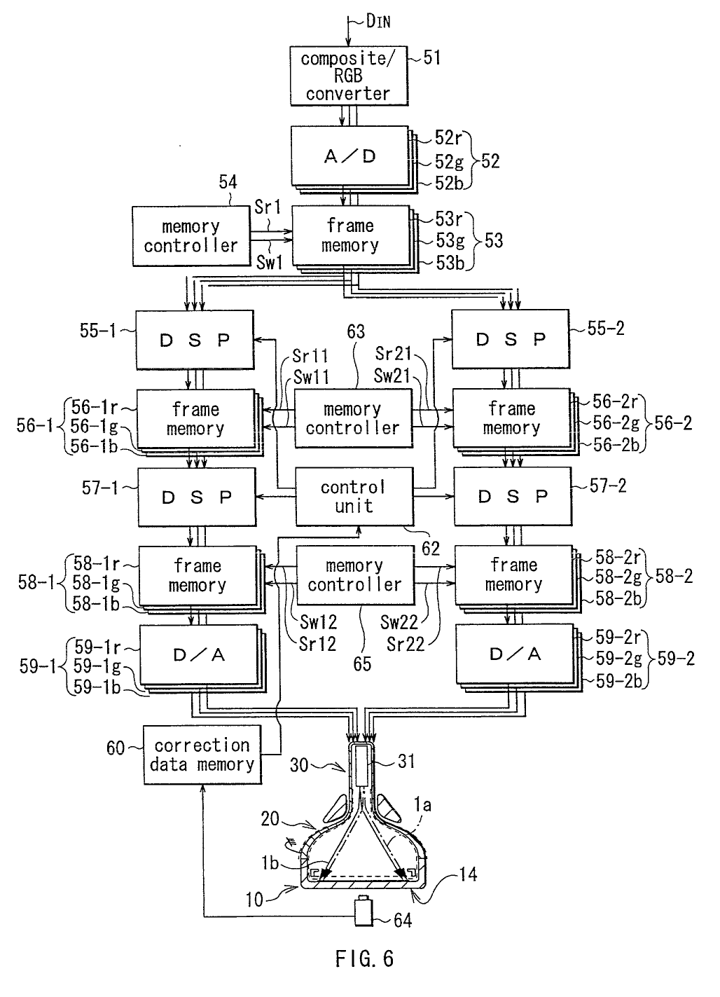

FIG. 6 shows an example of a circuit when an analog-composite signal with NTSC (National Television System Committee) method is inputted one-dimensionally as an picture signal (picture signal) DIN and a moving image is displayed according to the signal. The signal processing circuit shown in FIG. 6 corresponds to a specific example of a “image control device” of the invention.

The cathode ray tube according to the embodiment comprises, as shown in FIG. 6, a composite/RGB converter 51, an analog/digital signal (referred to as “A/D ” in the followings) converter 52 (52r, 52g, 52b), a frame memory 53 (53r, 53g, 53b) and a memory controller 54.

The composite/RGB converter 51 is for converting the analog-composite signal as the picture signal DIN into the signal for each color, R, G, and B. The A/D converter 52 is for converting the analog signal for each color outputted from the composite/RGB converter 51 into a digital signal. The frame memory 53 two-dimensionally stores the digital signal outputted from the A/D converter 52 by a frame unit by each and every color. For example, SDRAM (synchronous-dynamic-random access memory) is used for the frame memory 53. The memory controller 54 generates a recording address and a reading-out address of image data on/from the frame memory 53 and controls recording operation and reading-out operation of image data on/from the frame memory 53. The memory controller 54 controls the frame memory 53 to read/out and output the image data for image drawn by the electron beam group 1b on the top (referred to as image data for the top) and the image data for image drawn by the electron beam group 1a on the bottom (referred to as image data for the bottom). In the cathode ray tube, scanning is performed simultaneously in the same position on the phosphor screen by the electron beam group 1b on the top and the electron beam group 1a on the bottom. Therefore, two of substantially the same image data are outputted from the frame memory 53.

The cathode ray tube also comprises a DSP (digital signal processor) circuit 55-1, a frame memory 56-1 (56-1r, 56-1g, 56-1b), a DSP circuit 57-1, a frame memory 58-1 (58-1r, 58-1g, 58-1b), and a digital/analog signal (referred to as “D/A” in the followings) converter 59-1 (59-1r, 59-1g, 59-1b) for controlling the image data for the top. The cathode ray tube further comprises a DSP (digital signal processor) circuit 55-2, a frame memory 56-2 (56-2r, 56-2g, 56-2b), a DSP circuit 57-2, a frame memory 58-2 (58-2r, 58-2g, 58-2b), and a digital/analog signal (referred to as “D/A” in the followings) converter 59-2 (59-2r, 59-2g, 59-2b) for controlling the image data for the bottom.

The DSP circuits 55-1 and 55-2 correspond to specific examples of “first calculation means” of the invention and the DSP circuits 57-1 and 57-2 correspond to specific examples of “second calculation means” of the invention. The frame memories 56-1 and 56-2 correspond to specific examples of “first storing means of image data” and the frame memories 58-1 and 58-2 correspond to specific examples of “second storing means of image data” of the invention.

The cathode ray tube also comprises a correction data memory 60 for storing correction data for each and every color for correcting the display state of image, and a control portion 62 for controlling the calculation method of each DSP circuit while correction data is being inputted to from the correction data memory 60. The cathode ray tube also comprises a memory controller 63 for generating recording address and reading-out address of image data on/from the frame memories 56-1 and 56-2, and for controlling recording operation and reading-out operation of image data on/from the frame memories 56-1 and 56-2. The cathode ray tube further comprises a memory controller 65 for generating recording address and reading-out address of image data on/from the frame memories 58-1 and 58-2, and for controlling recording operation and reading-out operation of image data on/from the frame memories 58-1 and 58-2.

The A/D converter 52, the frame memories 53, 56-1, 56-2, 58-1, 58-2, the memory controllers 54, 63, 65, the DSP circuits 55-1, 55-2, 57-1 57-2, and the control portion 62 correspond to “position control means” of the invention.

The correction data memory 60 has memory regions for each and every color for both of the electron beam, groups on the top and bottom, and stores correction data in each memory region by each and every color. The correction data stored in the correction data memory 60 is generated at the time of, for example, manufacturing the cathode ray tube, for correcting image distortion and the like of the cathode ray tube at the initial stage. The correction data is generated based on the measurement of the amount of image distortion, misconvergence and the like displayed in the cathode ray tube.

An device for generating the correction data comprises an imager 64 such as a charge coupled device for imaging the image displayed in the cathode ray tube, and means for generating correction data (not shown in figure) for generating correction data based on the image imaged by the imager 64. The imager 64 images the screen displayed in the display screen 14 of the cathode ray tube by each and every color of both electron beam groups on the top and bottom, and outputs the image screen as image data by each and ever color of both the electron beam groups on the top and bottom. The means for generating correction data is formed of micro-computers and the like, and is formed to generate correction data based on data regarding the shift amount in each pixel from appropriate display position in the dispersed two-dimensional image data which represents the image imaged by the imager 64. It is possible to use the invention (Japanese Patent Application Laid-open Hei 11-17572) applied earlier by the applicant as for the device for generating correction data and correction processing of image using the correction data.

Each of the DSP circuits 55-1, 55-2, 57-1, and 57-2 is formed of, for example, a one-chip LSI (Large Scale Integrated Circuit) for general purposes and the like. Each of the DSP circuits performs various kinds of calculations on the inputted image data upon receiving an order from the control portion 62 in order to correct image distortion, misconvergence and the like in the cathode ray tube. The control portion 62 gives an order of calculation methods to each DSP circuit based on the correction data stored in the correction data memory 60.

The DSP circuit 55-1 mainly performs correction processing of position in the lateral direction on image data on the top by each and every color outputted from the frame memory 53, and outputs the correction result to the frame memory 56-1 by each and every color. On the other hand, the DSP circuit 57-1 mainly performs correction processing of position in the longitudinal direction on image data stored in the frame memory 56-1 by each and every color, and outputs the correction result to the frame memory 58-1 by each and every color.

The DSP circuit 55-2 mainly performs correction processing of position in the lateral direction on image data on the bottom by each and every color outputted from the frame memory 53, and outputs the correction result to the frame memory 56-2 by each and every color. On the other hand, the DSP circuit 57-2 mainly performs correction processing of position in the longitudinal direction on image data stored in the frame memory 56-2 by each and every color, and outputs the correction result to the frame memory 58-2 by each and every color.

The D/A converter 59-1 converts the corrected/calculated image data for the electron beam on the top outputted from the frame memory 58-1 to an analog signal by each and every color and outputs the analog signal to the respective cathode group K2 in the electron gun 31. On the other hand, the D/A converter 59-2 converts the corrected/calculated image data for the electron beam on the bottom outputted from the frame memory 58-2 to an analog signal by each and every color and outputs the analog signal to the respective cathode group K1 in the electron gun 31.

Each of the frame memories 56-1, 56-2, 58-1, and 58-2 two-dimensionally stores the calculated image data by a frame unit outputted from each of the DSP circuits 55-1, 55-2, 57-1, and 57-2, and outputs the stored image data by each and every color. Each of the frame memories is capable of high-speed random access. For example, SRAM (static RAM) is used for each of the memories. If each of the frame memories is formed of a single memory capable of high-speed random access, there may be a case where image is disturbed due to generation of interlace in the frame when performing recording operation and reading-out operation of image data. Therefore, it is possible that each of the frame memories has a double buffer structure using two memories.

The memory controller 63 is capable of generating reading-out address of image data stored in the frame memories 56-1 and 56-2 in a different order from that of recording address. The memory controller 65 is, in the same manner as in the memory controller 63, capable of generating reading-out address of image data stored in the frame memories 58-1 and 58-2 in a different order from that of recording address. In the embodiment, as described, it is possible to separately generate the orders of the recording address and the reading-out address in different orders. Therefore, image data at the time of recording to each frame memories 56-1, 56-2, 58-1, and 58-2 can be read-out with, for example, the image being rotated. The DSP circuit is generally suitable for a calculation processing in one direction. However, in the embodiment, it is possible to convert the image when necessary so that the image data becomes suitable for the calculation characteristic of the DSP circuit.

Next, operation of the cathode ray tube having the above-mentioned structure will be described.

The analog composite signal which is one-dimensionally inputted as the picture signal DIN is converted to a picture signal by each and every color, R, G, and B, by the composite/RGB converter 51 (FIG. 6), and is converted to a digital picture signal by each and every color by the A/D converter 52. At this time, it is preferable to perform IP (interlace progressive) conversion so that the processing thereafter becomes simple. The digital picture signal outputted from the A/D converter 52 is stored in the frame memory 53 by a frame unit by each and every color according to a control signal Sw1 showing the recording address generated in the memory controller 54. The image data stored in the frame memory 53 by a frame unit is read-out according to a control signal Sr1 showing the reading-out address generated in the memory controller 54 and then outputted to the DSP circuits 55-1, 55-2 as the image data for the top and bottoms.

The DSP circuits 55-1 and 57-1 perform calculation processing of image correction on the image data on the top outputted from the frame memory 53 based on the correction data stored in the correction data memory 60 upon receiving an order from the control portion 62. The calculated image data is converted to an analog signal by the D/A converter 59-1 and then is given as a cathode drive voltage to the cathode group K2 which emits the electron beam group 1b on the top.

The DSP circuits 55-2 and 57-2 perform calculation processing of image correction on the image data on the bottom outputted from the frame memory 53 based on the correction data stored in the correction data memory 60 upon receiving an order from the control portion 62. The calculated image data is converted to an analog signal by the D/A converter 59-2 and then is given as a cathode drive voltage to the cathode group K1 which emits the electron beam group 1a on the bottom.

Each of the cathodes composing the cathode groups K1 and K2 emits thermion with the amount according to the cathode drive voltage received. The electron beam group 1a (Ra, Ga, Ba) emitted from the cathode group K1 on the top receives the electron lens effect by the grid electrodes Gi to G5 and the convergence electrode 33, and then is emitted from the bottom in the electron gun 31 at last. On the other hand, an electron beam group 1b (Ra, Ga, Ba) emitted from the cathode group K2 on the bottom receives the electron lens effect by the grid electrodes G1 to G5 and the convergence electrode 33, and then is emitted from the top in the electron gun 31 at last.

Each of the electron beam group 1b on the top and the electron beam group 1a on the bottom emitted from the electron gun 31 is irradiated to the phosphor screen 11 through the color selection mechanism 12. At this time, the electron beam group 1b on the top and the electron beam group 1a on the bottom are simultaneously deflected by the magnetic effect of the deflection yoke 21 and simultaneously perform scanning on the same position on the phosphor screen. On the phosphor screen 11, two electron beams each for red, green, and blue, totaling six (3×2=6) are irradiated from the top and bottom forming scanning screens, respectively. Each of the scanning screens is superimposed as a whole thereby forming a single screen.

FIG. 8 shows a display example of rectangular image in the case where there is no correction processing performed by the DSP circuit. In FIG. 8, 5Rb, 5Gb, 5Bb respectively represent the display image formed by each of the electron beams Rb, Gb, Bb on the top, and 5Ra, 5Ga, 5Ba respectively represent the display image formed by each of the electron beams Ra, Ga, Ba on the bottom. As shown in FIG. 8, in general, there is a different image distortion in the display image by each of the electron beams. At this time, the display image 5b (5Rb, 5Gb, 5Bb) on the bottom formed by the electron beam group 1b (Rb, Gb, Bb) on the top is generally changed in its shape from rectangular to trapezoid with the bottom being wider. On the other hand, the display image 5a (5Ra, 5Ga, 5Ba) on the top formed by the electron beam group 1a (Ra, Ga, Ba) on the bottom is generally changed in its shape from rectangular to trapezoid with the top being wider.

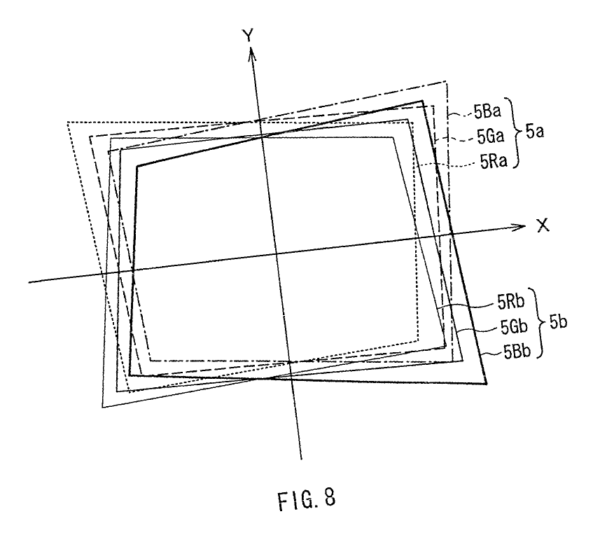

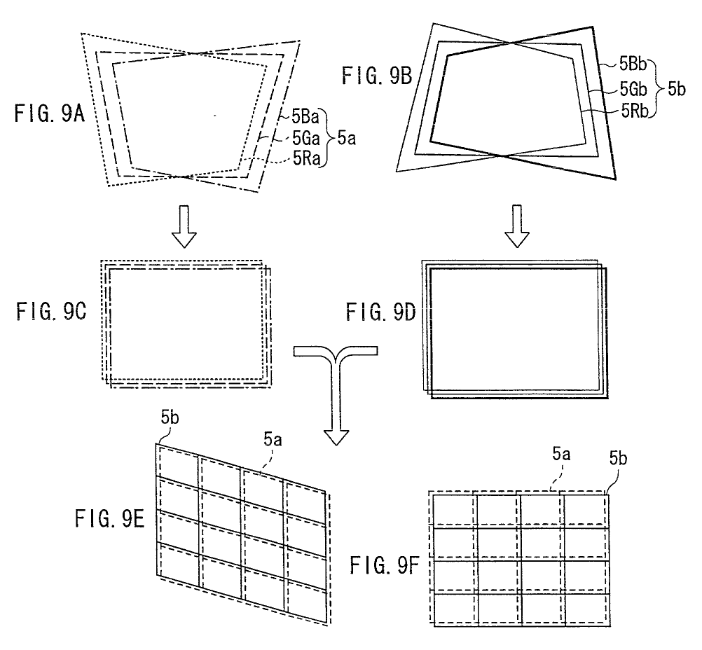

FIG. 9A to FIG. 9F show a model of display example of rectangular image when correction processing is performed in the cathode ray tube by the DSP circuit. Image distortion in the display image 5a on the bottom (FIG. 9A) is corrected as shown in FIG. 9C by correction processing of image performed by the DSP circuits 55-2 and 57-2, and an ideal rectangular image by each and every color is formed. In the same manner, image distortion in the display image 5b on the top (FIG. 9B) is corrected as shown in FIG. 9D by correction processing of image performed by the DSP circuits 55-1 and 57-1, and an ideal rectangular image by each and every color is formed. When the corrected display image 5b on the top and display image 5a on the bottom are simultaneously displayed, the display images by all the electron beams perfectly coincide with each other and appropriately superimposed as shown in FIG. 9E and FIG. 9F. FIG. 9E shows a perspective view of composite image of the display image 5b on the top and the display image 5a on the bottom. FIG. 9F is an elevation of the composite image. In FIG. 9C to FIG. 9F, positions of display images are drawn shifted from each other in order to clearly show the display images by each of the electron beams. However, the display positions of each of the images coincide with each other in practice.

Next, a specific example of correction/calculation processing of image data, which is the distinctive feature of the cathode ray tube, will be described. The correction/calculation processing performed on the image data on the top and the image data on the bottom is practically the same. Therefore, the calculation processing will be described hereinafter by mainly referring to the case of the image data on the top.

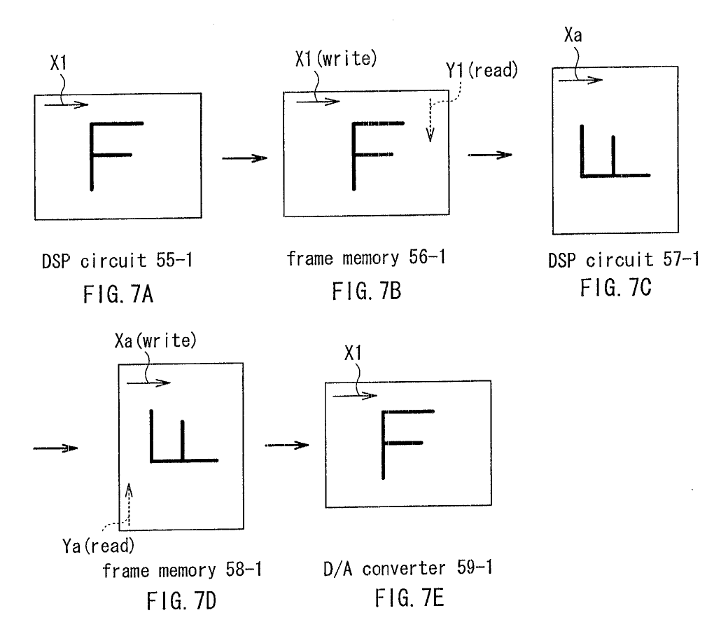

First, a total flow of the correction/calculation processing of image data performed in the processing circuit shown in FIG. 6 will be described by referring to FIG. 7A to FIG. 7E. FIG. 7A shows the image data which is read out from the frame memory 53 and inputted to the DSP circuit 55-1. Image data of, for example, 640 pixels in lateral ×480 pixels in longitudinal is inputted to the DSP circuit 55-1 in order in the right-hand direction (X1 direction in figure) starting from the pixel on the top-left as in, for example, the scanning direction of the screen shown in FIG. 1A. The DSP circuit 55-1 performs correction/calculation processing on the inputted image data for correcting image distortion or the like in the lateral direction based on the correction data stored in the correction data memory 60. At this time, processing of enlarging the image in the lateral direction may be performed in the DSP circuit 55-1. In order to increase the number of pixels, it is necessary to supply data regarding pixels which do not exist in the original image. It is possible to use, for example, the method disclosed in the patent (Japanese Patent Application Laid-open Hei 10-124656 and 2000-333102) applied earlier by the applicant as for the method of changing the number of pixels.

FIG. 7B shows the image data to be recorded on the frame memory 56-1 after receiving correction processing of the image by the DSP circuit 55-1. The image data which is calculation-processed in the DSP circuit 55-1 is stored in the frame memory 56-1 by each and every color according to a control signal Sw11 showing the recording address generated in the memory controller 63. In the example shown in FIG. 7B, the image data is recorded in order in the lateral direction (right-hand direction) from the top left. The image data stored in the frame memory 56-1 is read out by each and every color according to a control signal Sr11 showing the reading-out address generated in the memory controller 63 and inputted to the DSP circuit 57-1. In the embodiment, the order of recording address and the order of reading-out address on/from the frame memory 56-1 generated in the memory controller 63 are different. In the example shown in FIG. 7B, the image data is read out in order in the lateral direction (downward direction) from the top-right.

FIG. 7C shows the image data which is read out from the frame memory 56-1 and inputted to the DSP circuit 57-1. In the embodiment, the reading-out address from the frame memory 56-1 is in the reversed direction of that of the recording address. Therefore, the image to be inputted to the DSP circuit 57-1 is converted so that the whole image is rotated by 90° counterclockwise against the image shown in FIG. 7B. However, the direction of converting image is not limited to the one shown in the figure. For example, the image may be rotated by 90° clockwise.

The DSP circuit 57-1 performs the calculation processing on the image data (FIG. 7C) read out from the frame memory 56-1 for correcting image distortion or the like in the longitudinal direction based on the correction data stored in the correction data memory 60. At this time, processing of enlarging the image in the longitudinal direction may be performed in the DSP circuit 57-1. The image data inputted in the DSP circuit 57-1 is rotated by 90° so that the calculation processing is performed in the lateral direction (Xa direction in the figure) in the DSP circuit 57-1. However, the calculation processing is practically performed in the longitudinal direction considering it from the initial state of the image.

FIG. 7D shows the image to be recorded on the frame memory 58-1 after correcting the image by the DSP circuit 57-1. The image data which is calculation-processed in the DSP circuit 57-1 is stored in the frame memory 58-1 by each and every color according to a control signal Sw12 showing the recording address generated in the memory controller 65. In the example shown in FIG. 7D, the image data is recorded in order in the lateral direction (right-hand direction) from the top-left. The image data stored in the frame memory 58-1 is read out by each and every color according to a control signal Sr12 showing the reading-out address generated in the memory controller 65 and inputted to the D/A converter 59-1. In the embodiment, the order of recording address and the order of reading-out address on/from the frame memory 58-1 generated in the memory controller 65 are different. In the example shown in FIG. 7D, the image data is read out in order in the upward direction from the bottom-left. Thereby, the image to be inputted to the D/A converter 59-1 is converted by 90° in the reversed direction of the conversion (FIG. 7B and FIG. 7C) of the image, which is performed at the time of reading-out data in the frame memory 56-1. In other words, the whole image is converted by 90° clockwise against the state of the image shown in FIG. 7D.

An appropriate image display without image distortion and the like is performed in the scanning screens of the electron beams on the top by performing scanning of the electron beams on the top based on the image data (FIG. 7E) obtained through the calculation processing as described. At the same time, an appropriate image display without image distortion and the like is performed in the scanning screens by the electron beams on the bottom by performing scanning by the electron beams on the bottom through performing the calculation processing in the same manner. Thereby, the scanning screens of the electron beams on the top and bottom are appropriately positioned and superimposed to be displayed.

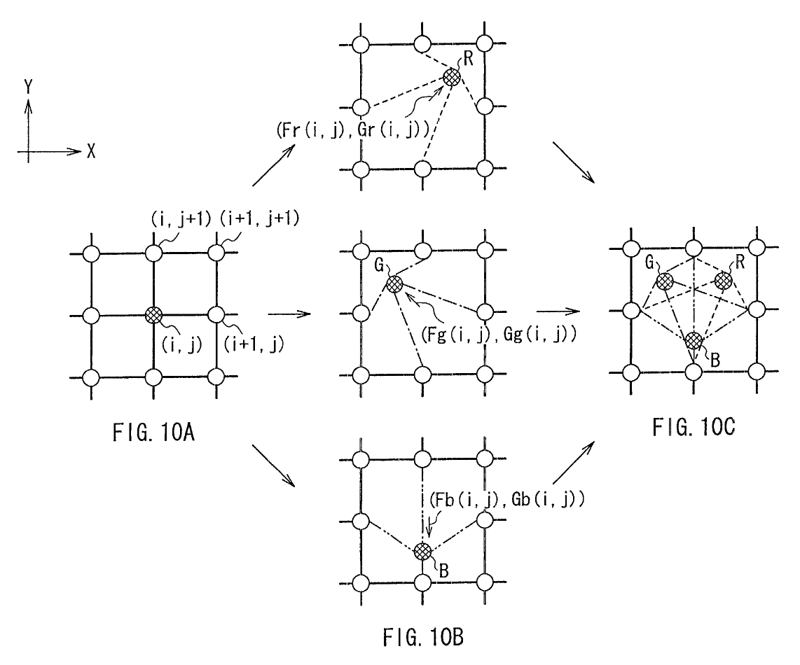

Next, the correction data stored in the correction data memory 60 (FIG. 6) will be briefly described by referring to FIG. 10. The correction data is shown, for example, by the shift amount from the reference point provided in a form of lattice. For example, the pixels of each color at the lattice point (i, j) becomes as shown in FIG. 10B when the following amount is shifted from the lattice point (i, j) shown in FIG. 10A as the reference point: the shift amount in R in X direction is Fr (i, j) and shift in Y direction is Gr (i, the shift amount in G in X direction is Fg (i, j) and shift in Y direction is Gg (i, j); a nd the shift amount in B in X direction is Fb (i , j ) and shift in Y direction is Gb (i, j). An image as shown in FIG. 10C can be obtained by superimposing each of the image shown in FIG. 10B. When the image obtained as described is displayed on the phosphor screen 11, misconvergence and the like is corrected as a result of the influence of image distortion characteristic of the cathode ray tube, geomagnetism and the like. Thereby, the pixels of R, G, and B are displayed on the same point on the phosphor screen 11. In the processing circuit shown in FIG. 6, correction based on the shift amount in X direction is performed in, for example, the DSP circuits 55-1 and 55-2, and correction based on the shift amount in Y direction is performed in, for example, the DSP circuits 57-1 and 57-2.

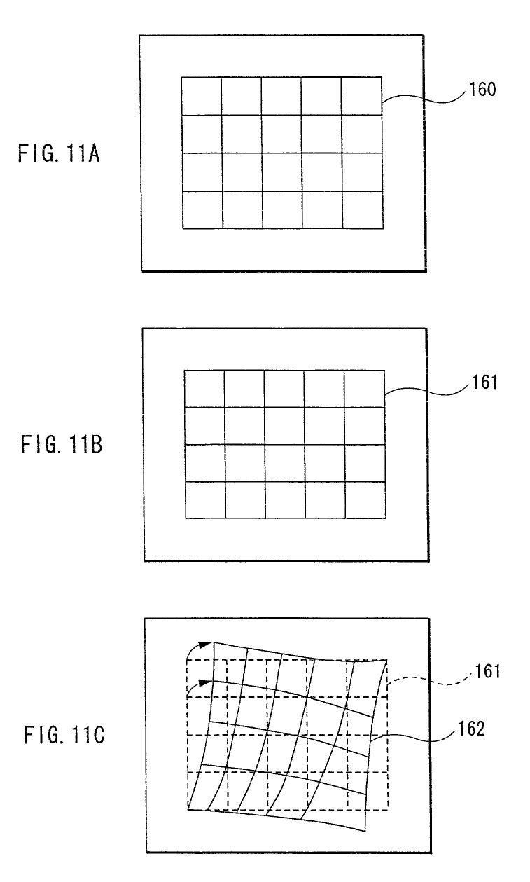

FIG. 11A to FIG. 11C show the converted state of the inputted image in a form of lattice when there is no correction/calculation using the correction data performed in the processing circuit shown in FIG. 6. In the case where no correction/calculation is performed, an image 160 (FIG. 11A) on the frame memory 53 and an image 161 (FIG. 11B) outputted to the D/A converter 59-1 (or D/A converter 59-2) are in the same form as the inputted image. After that, the image is distorted due to the characteristic of the cathode ray tube, and an image 162 which is converted as, for example, shown in FIG. 11C, is displayed in the tube screen 14. In FIG. 1C, the image shown with a dotted line corresponds to the image which should originally be displayed. In the process of displaying image as described, image distortion is a phenomenon where the images of each color R, G, B are converted in the perfectly same manner, and misconvergence is a case where the images are converted differently in each color. In order to correct the image distortion as shown in FIG. 11C, conversion may be performed in the reversed direction of the characteristic of the cathode ray tube before the picture signal is inputted to the cathode ray tube.

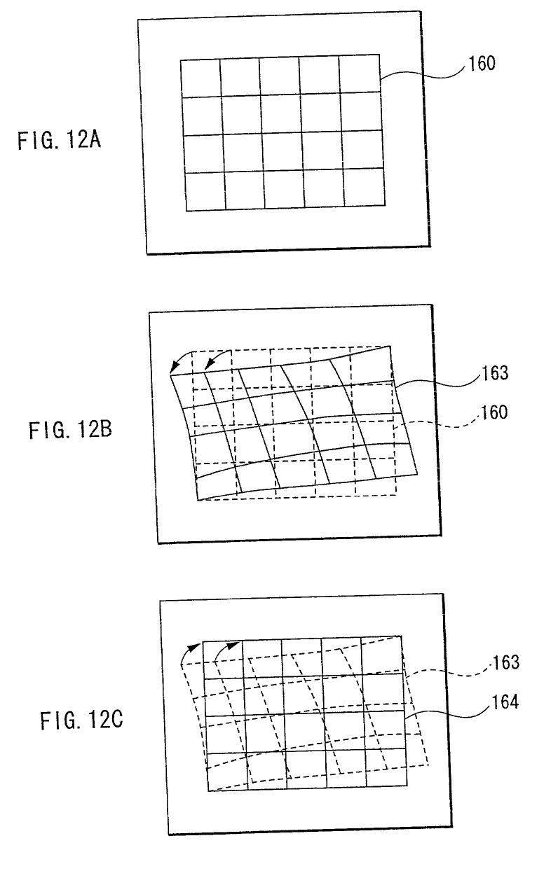

FIG. 12A to FIG. 12C show the change in the inputted image in a form of lattice when the correction/calculation is performed in the processing circuit shown in FIG. 6. The image 160 (FIG. 12A) on the frame memory 53 is in the same form as the inputted image also in the case where the correction/calculation is performed. The correction/calculation is performed on the image stored in the frame memory 53 by each of the DSP circuits 55-1 and 57-1 based on the correction data. Therefore, the image is converted in the reversed direction of the conversion (conversion due to the characteristic of the cathode ray tube itself, Ref FIG. 11C) of the inputted image in the cathode ray tube. An image 163 after the calculation is shown in FIG. 12B. In FIG. 12B, the image shown by a dotted line is the image 160 on the frame memory 53 corresponding to the image data before the correction/calculation is performed. As described, signal of the image 163 which is converted in the reversed direction of the distortion generated due to the characteristic of the cathode ray tube is then distorted by the characteristic of the cathode ray tube. Thereby, the image becomes the same form as that of the inputted image. As a result, an ideal image 164 (FIG. 12C) is displayed on the tube screen 14. In FIG. 12C, the image shown by a dotted line corresponds to the image 163 shown in FIG. 12B.

Next, the correction/calculation processing performed in the DSP circuits 55-1 and 57-1 (the DSP circuits 55-2 and 57-2) will be described. In the followings, the correction/calculation for R will be specifically described and description for G and B will be omitted unless there is an exception to be mentioned. Also, in the followings, there may be a case where corrections of image both in the lateral direction and longitudinal direction are described altogether at the same time. However, as described, corrections of the image in the longitudinal direction and the lateral direction are independently performed in the cathode ray tube.

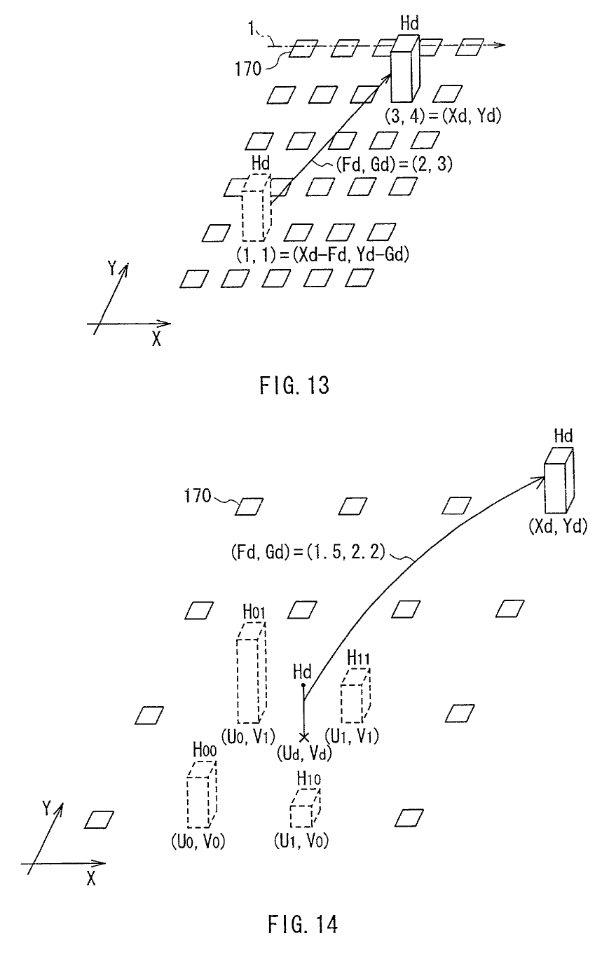

First, a first method of correction/calculation processing performed in the DSP circuits 55-1 and 57-1 will be described by referring to FIG. 13. In FIG. 13, each of pixels represented by a numeral 170 is provided on the positions of integers on XY coordinates in a form of lattice. FIG. 13 shows an example of calculation by putting emphasis on one pixel, displaying the state where the value of R signal (referred to as “R value” in the followings) Hd, which is the pixel value of the pixel on the coordinates (1, 1) before performing correction/calculation by the DSP circuits 55-1 and 57-1, is shifted to the coordinates (3, 4) after the calculation. In FIG. 13, the portion shown by a dotted line represents the R value (pixel value) before the correction/calculation. If the shift amount of the R value is shown by a vector, it can be expressed by (Fd, Gd)=(2, 3). It can be considered that the calculated pixel is, when the pixel is at the coordinates (Xd, Yd), a copy of the R value Hd at the coordinates (Xd-Fd, Yd-Gd). The image outputted as a display image is completed by copying each calculated pixel as described. Therefore, it is sufficient if the correction data stored in the correction data memory 60 have the shift amount (Fd, Gd) corresponding to each pixel after calculation.

The relation of shifts in the pixel value as described will be described in relates to the screen scanning of the cathode ray tube. In general, in the cathode ray tube, scanning in the horizontal direction is performed by an electron beam 1 from left of the screen to right (X direction in FIG. 13), and scanning in the vertical direction is performed from top of the screen to bottom (−Y direction in FIG. 13). Therefore, if the arrangement of the pixels is as shown in FIG. 13, scanning of the pixel at the coordinates (1, 1) is performed “after” the scanning of the pixel at the coordinates (3, 4) when scanning is performed based on the original picture signal. However, when scanning is performed based on the picture signal after the correction/calculation processing is performed by the DSP circuits 55-1 and 57-1, scanning of the pixel at the coordinates (1, 1) by the original picture signal is performed “before” the scanning of the pixel at the coordinates (3, 4) by the original picture signal. As described, in the embodiment, the arrangement of the pixels in the two-dimensional image data is re-arranged based on the correction data. As a result, the correction/calculation processing is performed so that the original one-dimensional picture signal is converted in terms of time and space.

When the values of the shift amount (Fd, Gd) used for the above-mentioned correction/calculation are limited to integers, a simple operation such as shift of the pixel value as described is sufficient to be performed as correction/calculation. However, when the image is corrected by calculation by limiting the value to integers, there may be many cases with problems such as so-called jaggy, which is a state where straight line in an image becomes notched line, and the size of the character image is not uniform, thereby looking unnatural. In order to solve the problems, the values of the shift amount (Fd, Gd) may be used after extending the values to real numbers and estimating the R value in a fictitious pixel.

Next, a second method of correction/calculation will be described by referring to FIG. 14. This is a method of correction/calculation when the values of shift amount (Fd, Gd) are real numbers. FIG. 14 shows the state when obtaining the R value Hd of the pixel after calculation when the correction data in the coordinates (Xd, Yd), that is, each value in the shift amount (Fd, Gd) is a real number. The coordinates (Ud, Vd) of the pixel before the calculation to be referred to are expressed by the following formula (1).

(Ud, Vd)=(Xd−Fd, Yd−Gd) (1)

If (Fd, Gd)=(1.5, 2.2), there is no pixel at the coordinates (Ud, Vd) since the pixels are at the coordinates only with integers. Therefore, in the second method, calculation is performed in which the R value of the pixel at the coordinates (Ud, Vd) is estimated by linear interpolation from four pixels near the coordinates (Ud, Vd). In FIG. 14, the portion shown by a dotted line represent the four pixels. At this time, if the integers obtained by reducing the decimal points in each of the values of the coordinates are the values U0, V0, and U1=U0+1, V1=V0+1, the pixels at the coordinates (U0, V0), (U1, V0), (U0, V1), (U1, V1) are the four pixels near the coordinates (Ud, Vd). When the R values of the pixels at the coordinates (U0, V0), (U1, V0), (U0, V1), (U1, V1) are H00, H10, H01, H11, respectively, the R value Hd of the pixel at the coordinates (Ud, Vd) to be obtained is expressed by the following formula (2).

Hd=(U1−Ud)×(V1−Vd)×H00+(Ud−U0)×(V1−Vd)×H10+(U1−Ud)×(Vd−V0)×H01+(Ud−U0)×(Vd−V0)×H11 (2)

When looking deeply into the second correction method as described heretofore, the pixel values (H00, H10, H01, H11) used for estimating the R value is selected and determined based on the integers in each value of the shift amount (Fd, Gd). Also, coefficient (for example, the coefficient of H00 is (U1-Ud) (V1-Vd)) of the each pixel value in the formula (2) is determined by the decimal place.

In the above-mentioned example, the R value of the pixel at the coordinates (Ud, Vd) is estimated by a method called linear interpolation from the four neighboring pixel values. However, the estimation method is not limited to this but other calculation methods may be used. In the example, the correction data is being taken as the relative difference in the coordinates for referring to the pixel value before the calculation, and a case is shown as an example where shift is performed to the coordinates (Xd, Yd) after correction after estimating the pixel value Hd at the fictitious coordinates (Ud, Vd). However, inversely, the correction data may be taken as the shift amount of the pixel value Hd before the calculation. Thereby, a calculation method may also be possible in which the calculated pixel value Hd is, after performing shift by the shift amount (Fd, Gd), allotted to the four pixel values near the coordinates after the shift.

The shift amount (Fd, Gd) as the correction data is separately defined for three colors, R, G, B in each pixel. Therefore, the total amount of data becomes so large that it cannot be bypassed when the correction data for all the pixels is provided. As a result, a memory with a large capacity for storing the correction data becomes necessary, which is a main factor for an increase in the cost of the device. Also, it takes quite a long time to measure the amount of image distortion and the amount of misconvergence in all the pixels in the correction data generating device (not shown in figure) including the imager 64 and to calculate the correction data to be given to the cathode ray tube. On the other hand, there is not much difference in the pixels located close to each other regarding the amount of image distortion or the amount of misconvergence of the cathode ray tube. Thereby, a method may be used in which the region of the whole screen is divided into a number of regions, the correction data is given to a typical pixel in each divided region, and the correction data of the other pixels is estimated from the correction data of the typical pixel. The method is effective for reducing the total amount of the correction data and shortening the time spent for the operation.

Next, as a third method of correction/calculation, the method will be described in which the correction/calculation is performed by supplying the correction data only to the typical pixel. The shift of pixels in the divided region is determined based on the shift amount of the typical pixel. Therefore, in the followings, the points where the typical pixels are will be called “control points.”

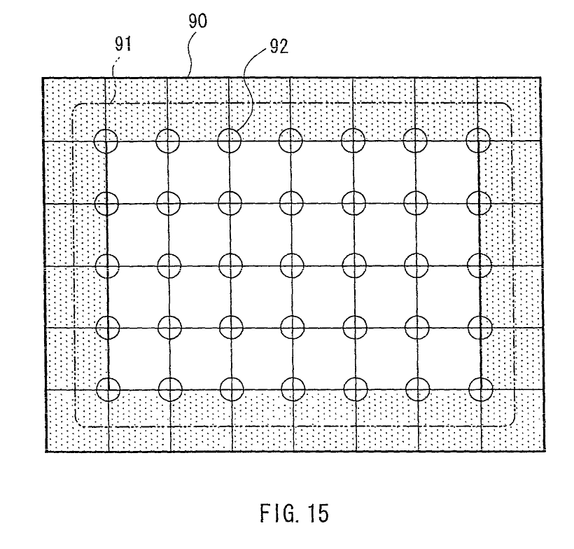

FIG. 15 shows an example of the reference image for correction used in the third method of correction/calculation. In FIG. 15, an example of two-dimensional image in a form of lattice in which, for example, 640 pixels in lateral×480 pixels in longitudinal is divided to 8 blocks in lateral and 6 blocks in longitudinal. The above-mentioned control points are provided at each lattice point in such image. In the case of television screens and the like, image information with the size larger than the screen size which is actually displayed on the tube screen of the cathode ray tube is supplied, and there is a region called an over-scan existed. Therefore, as shown in FIG. 15, an image region 90 on the DSP circuit is generally provided larger than an effective image region 91 of the cathode ray tube with the over-scan region being taken into account. On the DSP circuit, a number of control points 92 are provided to serve also as the control points of the neighboring divided regions. In the example shown in FIG. 15, the total number of the control points 92 is only 35 (7 in lateral×5 in longitudinal). As described, by using the method of supplying the typical control point 92 as the correction data, the amount of data for correction data is remarkably reduced so that the capacity of the correction data memory 60 can be reduced compared to using the method in which the correction data is supplied to all the pixels. Also, not only the capacity but also the time for correcting the image can be remarkably reduced at the same time.

It is not necessary to provide the control points in a form of lattice as shown in figure but may be provided in any other given form.

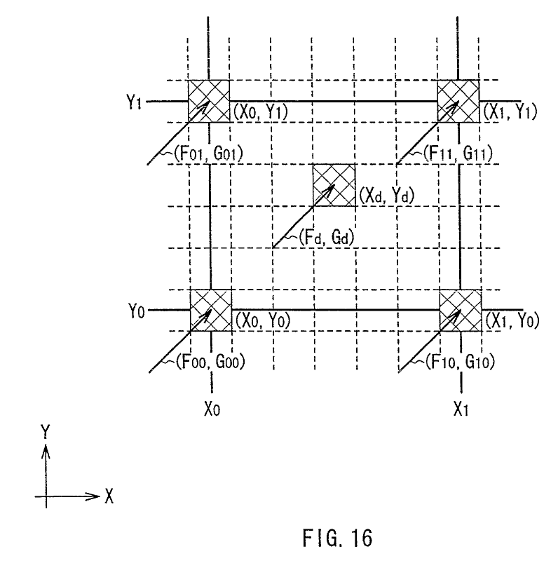

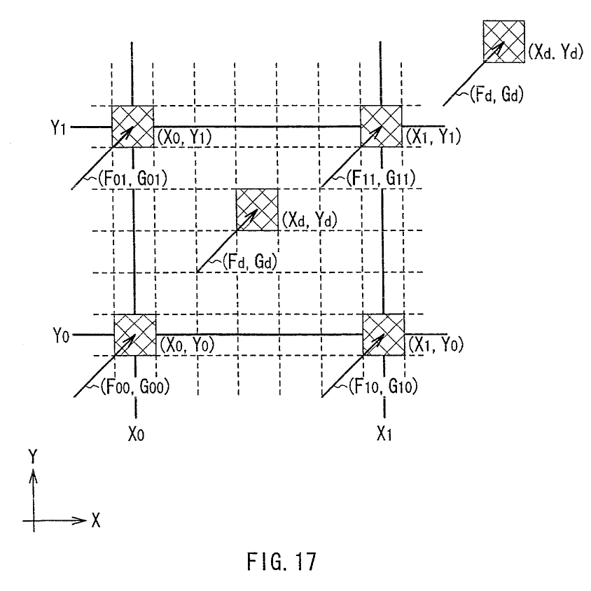

Next, a method of obtaining the shift amount of any given pixel in each divided region will be described by referring to FIG. 16 and FIG. 17, when the control points are provided in a form of lattice as shown in FIG. 15. FIG. 16 is for describing a method in which the shift amount is obtained by interpolation and FIG. 17 is for describing a method in which the shift amount is obtained by extrapolation. Interpolation is a method of interpolating the shift amount of a given pixel located inside a plurality of control points while extrapolation is a method of interpolating the shift amount of a given pixel located outside a plurality of control points. It is possible to use extrapolation for all the pixels. However, it is desirable to use extrapolation only for the case of the pixels in the peripheral region (hatching region shown in FIG. 15) of the screen. As described, in general, extrapolation is used for the divided region on the periphery of the screen including the outer frame of the whole image region, and interpolation is used for the other regions. Both of the cases can be expressed by substantially the same calculation method. In the figures, if the coordinates of the four control points are (X0, Y0), (X1, Y0), (X0, Y1), (X1, Y1) and the shift amounts corresponding to the respective correction data are (F00, G00), (F10, G10), (F01, G01), (F11, G11), the shift amount (Fd, Gd) in a given pixel at the coordinates (Xd, Yd) can be obtained by the following formulas (3) and (4). The calculation formulas can be used for both interpolation and extrapolation.

Fd={(X1−Xd)×(Y1−Yd)×F00+(Xd−X0)×(Y1−Yd)×F10+(X1−Xd)×(Yd−Y0)×F01+(Xd−X0)×(Yd−Y0)×F11}/{(X1−X0)(Y1−Y0)} (3)

Gd={(X1−Xd)×(Y1−Yd)×G00+(Xd−X0)×(Y1−Yd)×G10+(X1−Xd)×(Yd−Y0)×G01+(Xd−X0)×(Yd−Y0)×G11}/{(X1−X0)(Y1−Y0)} (4)

The calculations expressed by the formulas (3) and (4) are also estimation methods by linear interpolation. However, the estimation methods are not limited to linear interpolation but other calculation methods may be used.

As described, in the embodiment, the picture signal which is inputted one-dimensionally is converted to a dispersed two-dimensional image data. The arrangement of the pixels in the two-dimensional image data is changed by each cathode in terms of time and space so that all of a plurality of scanning screens formed by each electron beam are appropriately located and interposed when performing image display. Then, control is performed in which the image data is re-converted to a picture signal for display to be outputted. In the manner as described, positions of all the scanning screens formed by each electron beam of the electron beam group 1b on the top and the electron beam group 1a on the bottom can be corrected to be superimposed. At this time, correction of the image data is performed separately on the data for each electron beam and the arrangement of the pixels are corrected both in the lateral and longitudinal direction. Therefore, each of the scanning screens can be corrected by a pixel unit in any given direction so that image distortion and misconvergence can be lessened compared to using a method in which image is controlled electromagnetically by a deflection yoke or the like. Thereby, the image display using a multi-beam electron gun can be excellently performed according to the embodiment.

In the embodiment, scanning of the same position on the phosphor screen are simultaneously performed by the electron beam group 1b on the top and the electron beam group 1a on the bottom, and 1 frame (1 field in the case of interlace scanning) of screen is formed as a whole. Therefore, intensity can be improved compared to a cathode ray tube of the related art in which scanning is performed by one electron beam for each color. Especially, if the intensity is to be improved using an electron gun of the related art, the amount of electron beam emitted from one cathode becomes large, which may result in deterioration of focus. However, according to the embodiment, the amount of electron beam emitted from one cathode can be lessened so that the intensity can be improved without deteriorating the focus. Also, voltage applied to one cathode can be suppressed to be low compared to the cathode ray tube of the related art. Thereby, the consumption of electricity can be minimized.

[Second Embodiment]

Next, a second embodiment of the invention will be described.

In the embodiment, each scanning of the screen in different positions is performed by the electron beam group 1b on the top and the electron beam group 1a on the bottom and 1 frame or 1 field of image is displayed.

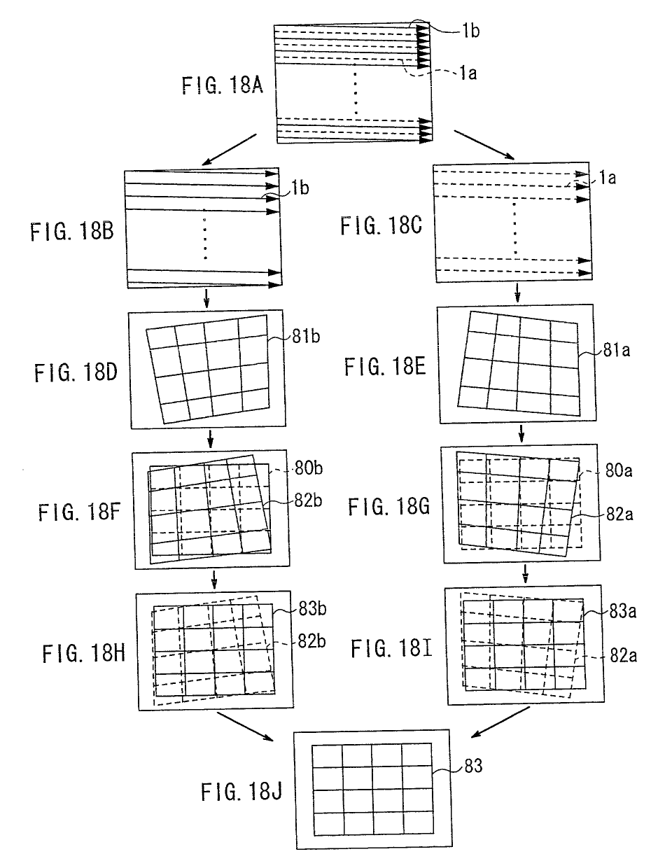

FIG. 18A to FIG. 18J show a model outline of screen scanning in the cathode ray tube according to the second embodiment of the invention in relation to correction processing of the image. In the followings, a case where the image is displayed by a sequential scanning method will mainly be described.

In the cathode ray tube, scanning by the electron beam group 1b on the top and the electron beam group 1a on the bottom is alternately performed in different positions on the phosphor screen by a horizontal scanning unit so that sequence scanning is performed as a whole. At this time, screen scanning of 1 frame (FIG. 18A) is separately performed by, for example, screen scanning of odd-number field (FIG. 18B) by the electron beam group 1b on the top and screen scanning of even-number field (FIG. 18C) by the electron beam group 1a on the bottom. However, unlike the interlace scanning method in which vertical scanning is performed twice separately for scanning of an odd-number field and scanning of an even-number field, vertical scanning is performed once as a whole. At first, the first horizontal scanning of the odd-number field is performed by the electron beam group 1b on the top and then the first horizontal scanning of the even-number field is performed by the electron beam group 1a on the bottom. Thereinafter, i th (i is an integer) horizontal scanning of the odd-number field is performed by the electron beam group 1b on the top and i th (i is an integer) horizontal scanning of the odd-number field is performed by the electron beam group 1a on the bottom in order. As described, scanning of each field is alternately performed by the electron beam group 1b on the top and the electron beam group 1a on the bottom.

The correction processing of the image in the cathode ray tube is performed in the same manner as that in the first embodiment. In other words, control of the image data for the top is performed by the DSP circuit 55-1, the frame memory 56-1, the DSP circuit 57-1, the frame memory 58-1 and the D/A converter 59-1. Control of the image data for the bottom is performed by the DSP circuit 55-2, the frame memory 56-2, the DSP circuit 57-2, the frame memory 58-2 and the D/A converter 59-2. At this time, the frame memory 53 divide 1 frame of image data into an even-number field of data and an odd-number field of data, and then outputs the odd-number field of data to the DSP circuit 55-1 as the image data for the top. Also, the frame memory 54 outputs the even-number field of data to the DSP circuit 55-2 as the image data for the bottom.

FIG. 18D shows an example of image displayed on the tube screen formed by the electron beam group 1b on the top when correction processing of the image is not performed. On the other hand, FIG. 18E shows an example of image displayed on the tube screen formed by the electron beam group 1a on the bottom when correction processing of the image is not performed. When the correction processing is not performed, a rectangular image is displayed being distorted, for example, like display images 81b and 81a shown in FIG. 18D and FIG. 18E due to the characteristic of the cathode ray tube.

The DSP circuits 55-1 and 57-1 perform correction processing of the image on the image data for the top so that the image is changed in the reversed direction of the distortion in the displayed image 81b shown in FIG. 18D. The image 82b shown in FIG. 18F shows the state of the image data after the correction processing is being performed. In FIG. 18F, an image 80b shown by a dotted line shows the state of the image data before the correction/calculation is being performed. As a result of scanning based on the image data after correction processing of the image is performed by the electron beam group 1b on the top, an image 83b (FIG. 18H) with an ideal shape is displayed on the tube screen 14.

On the other hand, the DSP circuits 55-2 and 57-2 perform correction processing of the image on the image data for the top so that the image is changed in the reversed direction of the distortion in the displayed image 81a shown in FIG. 18E. The image 82a shown in FIG. 18G shows the state of the image data after the correction processing is performed. In FIG. 18G, an image 80a shown by a dotted line shows the state of the image data before the correction/calculation is being performed. As a result of performing scanning based on the image data after correction processing of the image is performed by the electron beam group 1a on the bottom, an image 83a (FIG. 181) with an ideal shape is displayed on the tube screen 14.

By composing the scanning screens formed by the electron beam group 1b on the top and the electron beam group 1a on the bottom which is appropriately corrected in terms of the positions as described, the composite image 83 is appropriately superimposed in terms of positions and displayed.

The embodiment has been described by referring to the case where the image is displayed by a sequential scanning method. However, it is also applicable to the case where the image is displayed by interlace scanning method. In the case of interlace scanning, scanning by the electron beam group 1b on the top and the electron beam group 1a on the bottom is also alternately performed in different positions by one horizontal scanning unit. At this time, for example, 1 field of image is further divided into half, and scanning of ½ field is to be performed by each of the electron beam groups. The scanning of ½ field is performed not by separately performing vertical scanning twice but by performing vertical scanning once as a whole.

As described, in the embodiment, screen scanning is performed in different positions within the same frame (in the case of sequential scanning) or the same field (in the case of interlace scanning) by the electron beam group 1b on the top and the electron beam group 1a on the bottom, and 1 frame or 1 field of image is superimposed to be displayed as a whole. Therefore, image display by a sequential scanning method or interlace scanning method can be performed with scanning frequency as low as half of that of the related art.

The invention is not limited to the above-mentioned embodiments but various kinds of modifications are possible. For example, although a cathode ray tube capable of color display is described in the above-mentioned embodiments, the invention is applicable to a cathode ray tube which performs monochrome display. Also, an electron gun having two cathodes for each and every color, totaling six cathodes, is described in the embodiments. However, the invention is applicable to an electron gun having three cathodes and more for each and every color. In addition, in the above-mentioned embodiments, a case where a plurality of cathode groups are provided in parallel in the top-and-bottom direction is described as the structure of the electron gun. However, the invention is applicable to a case using an electron gun having a structure in which a plurality of cathode groups are provided in parallel in other directions (for example, horizontal direction).

Also, in each of the embodiments, an example of using NTSC-type analog composite signal as the picture signal D_{IN} is described. However, the picture signal D_{IN} is not limited to this. For example, RGB analog signal may be used as the picture signal D_{IN}. Also, digital signal used in digital televisions may be inputted as the picture signal D_{IN}. In this case, digital signal can be obtained directly without using the A/D converter 52 (FIG. 6). In both cases where either one of the picture signals is used, almost the same circuit structure is applicable after the frame memory 53 in the example of a circuit shown in FIG. 6.

In each of the embodiments, screen scanning of the same frame (or the same field) is performed by each electron beam group by scanning of different positions by the electron beam groups on the top and bottom. However, an electron beam may be alternately emitted from different cathode group by every 1 frame (1 field in the case of interlace scanning) and screen scanning may be performed by the different electron beam groups by every 1 frame (or 1 field).

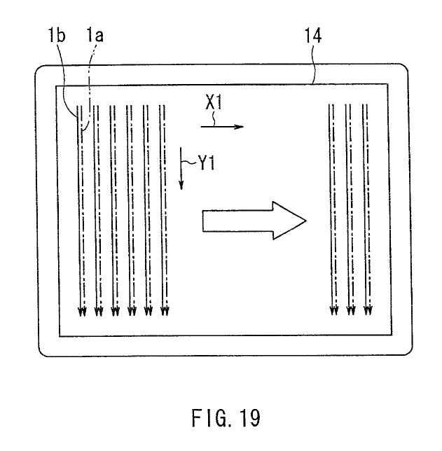

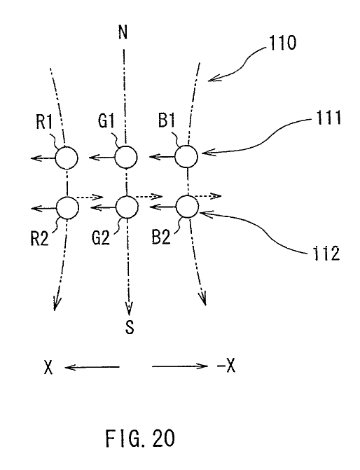

Also, in each of the embodiments, as shown in FIG. 1A, a case where line scanning by electron beam is performed in the horizontal direction and the field scanning is performed from top to bottom is described. However, the invention, as shown in FIG. 19, is applicable to so-called a longitudinal scanning type cathode ray tube which performs line scanning by the electron beam from top to bottom and performs field scanning in the horizontal direction. In this case, it is desirable that the electron gun has the structure in which a plurality of cathode groups are provided in parallel in the horizontal direction.

Obviously many modifications and variations of the present invention are possible in the light of above teachings. It is therefore to be understood that within the scope of the appended claims the invention may be practiced otherwise than as specifically described.

What is claimed is:

1. A cathode ray tube comprising: an electron gun having a plurality of cathode groups including a cathode for at least one color, and emitting electron beams from each of the cathodes according to a picture signal;
an image display where a plurality of scanning screens are performed by a plurality of the electron beams emitted from each cathode of the electron gun and a single screen is formed by a plurality of the scanning screens being superimposed as a whole;
a storing means for storing correction data for correcting display state of image which is obtained based on an image displayed on the image display;
a converting means for converting a picture signal inputted one-dimensionally into a dispersed two-dimensional image data; and
a position control means for controlling by correcting through changing the arrangement of pixels in the two-dimensional image data converted by the converting means in terms of time and space by each and every cathode based on the correction data stored in the storing means and then by outputting the corrected image data after re-converting it to a picture signal for display so that a plurality of the scanning screens are appropriately positioned and superimposed to be displayed when image display is performed on the image display.

2. A cathode ray tube as claimed in claim 1, wherein 1 frame or 1 field of image is displayed as a whole by performing screen scanning on the same position simultaneously by a plurality of electron beams emitted from a plurality of the cathode groups.

3. A cathode ray tube as claimed in claim 1, wherein 1 frame or 1 field of image is superimposed to be displayed as a whole by performing screen scanning in different positions in the same frame or the same field by a plurality of electron beams emitted from a plurality of the cathode groups.

4. A cathode ray tube as claimed in claim 1, wherein screen scanning is alternately performed by different electron beams by every 1 frame or 1 field.

5. A cathode ray tube as claimed in claim 1, wherein cathode groups formed including cathodes for three colors, red, green, and blue, are provided in the electron guns in two parallel lines in the up-and-down or horizontal direction.

6. A cathode ray tube as claimed in claim 1, wherein the position control means comprises:
a first calculation means for performing calculation for correcting the arrangement of pixels in the image data in the lateral direction based on the correction data so that a plurality of the scanning screens are appropriately positioned and superimposed in the lateral direction to be displayed; and
a second calculation means for performing calculation for correcting the arrangement of pixels in the image data in the longitudinal direction based on the correction data so that a plurality of the scanning screens are appropriately positioned and superimposed in the longitudinal direction to be displayed.

7. A cathode ray tube as claimed in claim 6, wherein the position control means further comprises:
a first image data storing means for storing image data in the lateral direction in order which is outputted from the first calculation means, reading out the stored image data in the longitudinal direction, and then outputting the image data to the second calculation means in a state being converted by 90°; and
a second image data storing means for storing image data which is outputted from the second calculation means and outputting the image data to the second image data storing means in a state being converted by 90° in the opposite direction of that in converting image in the first image data storing means.

8. An image control device for controlling display of image in a cathode ray tube comprising an electron gun having a plurality of cathode groups including a cathode for at least one color, and an image display where a plurality of scanning screens are formed by a plurality of the electron beams emitted from each cathode of the electron gun and a single screen is formed by a plurality of the scanning screens being superimposed as a whole; wherein the image control device comprises:
a storing means for storing correction data for correcting display state of image which is obtained based on an image displayed on the image display;
a converting means for converting a picture signal inputted one-dimensionally into a dispersed two-dimensional image data; and
a position control means for controlling by correcting through changing the arrangement of pixels in the two-dimensional image data converted by the converting means in terms of time and space by each and every cathode based on the correction data stored in the storing means and then by outputting the corrected image data after re-converting it to a picture signal for display so that a plurality of the scanning screens are appropriately positioned and superimposed to be displayed when image display is performed on the image display.
